(19) United States
(12) Patent Application Publication
(10) Pub. No.: US 2005/0039300 A1
(43) Pub. Date: Feb. 24, 2005

(54) Infection control wrap

(76) Inventors: Laurence W. Riebau, Spring Hill, FL (US); Theodore P. Scallan, Fort Walton Beach, FL (US)

Correspondence Address: Laurence W. Riebau, 7245 Blackbird Ave, Spring Hills, FL, 34613, US

(21) Appl. No.: 10/646,002

(22) Filed: Aug. 22, 2003

(51) Int. Cl. E05B 1/00

(52) U.S. Cl. 16/110.1

(57) ABSTRACT

A disposable protective cover intended to be applied to shared medical, physical therapy and physical equipment, devices and accessories to aid in the prevention of transference of bacteria and viruses among user of such equipment. The covers are produced formed from a cohesive coated laminated non-porous Polyethylene plastic foam pad, non-latex rubber material that is produced with an even coat of pressure sensitive removable restickable self-adhesive applied completely over the back surface of the material on the equipment-contacting side of the pad allowing a non-slip cover and provides sanitary surface on the patient contact surface. The protective covers are provided in sheet or roll form for use with or without a dispenser.

### BACKGROUND OF THE INVENTION

The invention relates generally to medical, physical therapy and physical exercise equipment, devices and accessories and more particularly to disposable protective covers for such shared medical, physical therapy and physical exercise equipment, devices and accessories. Such medical, physical therapy and physical exercise equipment, devices and accessories such as walkers, canes, wheelchairs and physical exercise equipment must be shared by multiple users because they are used infrequently by each individual user and are too expensive to dispose of after individual use. As it has been proven that transference of viruses and bacteria from one person to another is highest on items which come into common physical contact, bacteria and viruses can pass among users of shared medical, physical therapy and physical exercise equipment, devices and accessories.

It is thus desirable to provide a protective covering that will allow users to have sanitary surfaces on shared medical, physical therapy and physical equipment, devices or accessories to aid in the prevention of transferring the spread of bacteria and viruses between users.

### BRIEF SUMMARY OF THE INVENTION

The invention is produced as protective covers formed from a cohesive coated laminated non-porous Polyethylene plastic foam pad non-latex rubber material, which provides a non-slip that is produced with an even coat of pressure sensitive removable restickable self-adhesive surface on the side of the pads contacting equipment, device and accessories and a non-slip sanitary surface on the side contacted by persons using such equipment, devices and accessories. The protective covers, for use with or without a dispenser, are provided in a roll that has perforations at predetermined intervals to allow the user to tear off one or more sections to achieve a cover of a desired size or in a stack of separate sheets of predetermined size.

### BRIEF DESCRIPTION OF THE SEVERAL VIEWS OF THE DRAWING

In the accompanying drawings forming a part of this specification and in which like reference characters are employed to designate like parts throughout the same:

FIG. 1 is a perspective view of examples of various dispensers to be used for dispensing the sheets of protective covering from either the perforated roll or flat sheet composition.

FIG. 2 (1) is a view of the two sides of an individual section of the protective non-porous covering material showing the exterior user-contact surface produced with the non-slip texture and the medical, physical therapy and physical equipment-contact surface side produced with the removable restickable self-adhesive to prevent the cover from slipping its position during use.

FIG. 3 is a perspective view showing the protective covers as they are to be applied to various user-contact surfaces on a variety of medical equipment, devices and accessories that are often shared among multiple users.

### DETATILED DESCRIPTION OF THE INVENTION

The invention is the use of protective covers formed from a cohesive coated laminated non-porous Polyethylene plastic foam pad non-latex rubber material to provide a two-sided flexible thin pad consisting of a non-slip that is produced with an even coat of pressure sensitive removable restickable self-adhesive surface on the side of the pads that contacts the equipment, device and accessories and a non-slip sanitary surface on the side contacted by persons using such equipment, devices and accessories. The protective covers, for use with or without a dispenser, are either provided in a roll that has perforations at predetermined intervals to allow the user to tear off one or more sections to achieve a cover of a desired size or are provided as a stack of individual sheets of predetermined size. FIG. 1, 3 and 3A include dispensers for dispensing protective covers. In 3 a roll dispenser is illustrated while 3A shows a dispenser for covers produced in a sheet format.

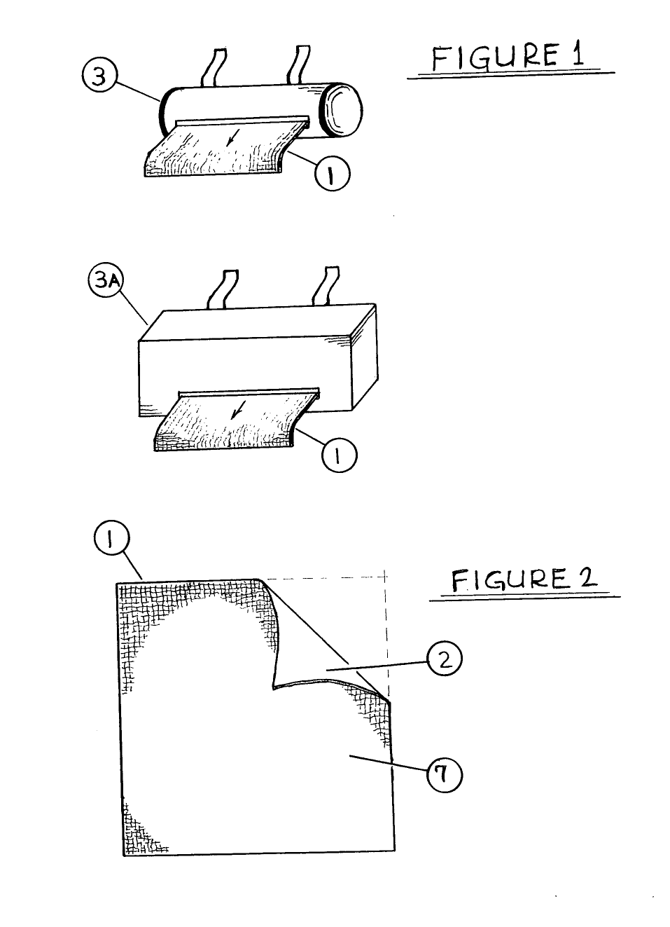

The protective pads are produced as rolls in sizes which allow a single person to easily hold and tear off individual sections for a cover of desired size and as flat sheets in convenient sizes for coverage of commonly shared surfaces areas. The self-adhesive on the one side of the pads affixes to any surface quickly without excessive handling. The removable adhesive also allows the cover to be easily removed from the surface it covers in one piece when users have finished with the use of the equipment. In both cases, the protective covers are formed as shown in FIG. 2, from a 1 two-sided cohesive coated laminated non-porous Polyethylene plastic foam pad, non-latex rubber material that is produced with 2 a that is produced with an even coat of pressure sensitive removable restickable self-adhesive surface on the equipment-contacting side of the pad and 7 a non-slip raised textured surface on the user-contact sides of the side.

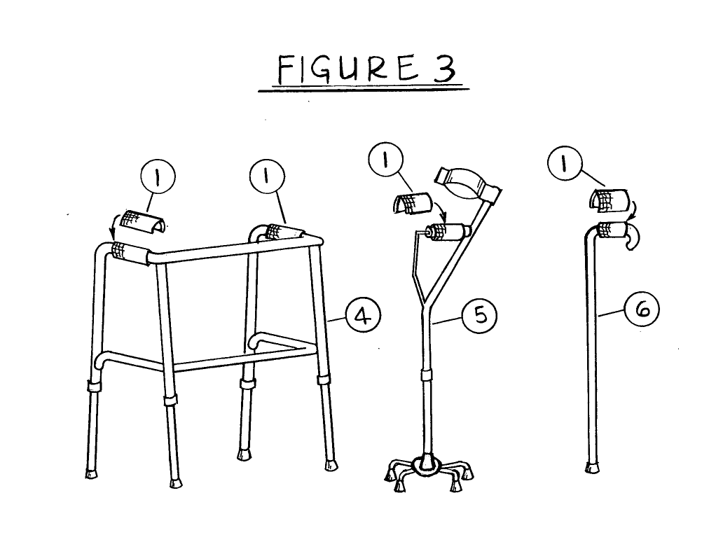

Currently shared medical, physical therapy and physical exercise equipment is manufactured with non-porous surfaces in the many areas of physical contacts. It has been proven that transference of viruses and bacteria from one person to another is highest on items which come into common physical contact. Users of such shared equipment such as hospitals, physical therapy offices and gymnasiums currently use various methods in an effort to provide a clean surface on these shared contact surfaces between users. Use of the non-porous self-adhesive removable restickable covers sized to allow quick and total coverage of the user contact surfaces of shared medical, physical therapy and physical equipment will provide a new sanitary surface for each person using such equipment and aid in the prevention of inadvertent transference of viruses and bacteria from one user to another. In use, FIG. 3, the protective covers 1 are adhesively secured to various devices at user-contact surfaces such as cane 5 cane 6 and walker 4. The protective covers 1 are easily applied prior to use and then removed and disposed of after each use.

It can be seen from the proceeding description that a disposable sanitary protective cover for shared surfaces of medical, physical therapy and physical equipment, devices and accessories has been provided.

It is noted that the embodiment of the disposable protective cover for shared medical, physical therapy and physical equipment, devices and accessories described herein for exemplary purposes is subject to many different variations in structure, design, application and methodology. Because many varying and different embodiments may be made within the scope of the inventive concept(s) herein, and because many modifications may be made in accordance with the descriptive requirements of the law, it is to be understood that all such forms of such device covers be embodied into the parameters of such uses.

1. What we as joint inventors claim is that use of the protective covering known as “I C WRAP” will provide a sanitary cover to aid in the prevention of the spread of viruses and bacteria among persons sharing medical, physical therapy and physical equipment, devices and accessories by:
allowing everyday usage of medical, physical therapy and physical exercise equipment by multiple users. The I C WRAP is composed of a cohesive coated laminated non-porous Polyethylene plastic foam pad, non-latex rubber material that is produced with a non-slip, removable restickable self-adhesive surface on the equipment-contacting side and a non-slip sanitary surface on the patient-contact surface. The protective covers for use with or without being provided in a roll of covers that have perforations at predetermined spaced intervals that allow the user to tear off one or more sections to achieve a cover of a desired size or in flat sheets;
use of I C WRAP in rolls or sheet sections is easily pulled from a container or box allowing the self-adhesive side of the cover to be placed over the selected surface of the equipment to which the cover adheres on contact providing a sanitary non-grip cover to the shared surface.
